(19) United States
(12) Patent Application Publication
(10) Pub. No.: US 2026/0209022 A1
(43) Pub. Date: Jul. 23, 2026

(54) SCOOPING APPARATUS

(71) Applicant: Dallas Connell, Lakeland, FL (US)

(72) Inventor: Dallas Connell, Lakeland, FL (US)

(21) Appl. No.: 18/735,174

(22) Filed: Jun. 6, 2024

Related U.S. Application Data
(60) Provisional application No. 63/471,431, filed on Jun. 6, 2023.

(51) Int. Cl. B67C 11/02; G01F 19/00

(52) U.S. Cl. CPC B67C 11/02; G01F 19/002

(57) ABSTRACT

A scooping apparatus is described. In some implementations, the scooping apparatus can include a scoop portion defining a scoop interior space. In some implementations, the scooping apparatus can include a hollow handle portion extending from the scoop portion. In some implementations, the hollow handle portion defines a handle interior space disposed in communication with the scoop interior space of the scoop portion. In some implementations, the hollow handle portion includes a proximal end with an ingress opening and a distal end with an egress opening. In some implementations, the handle portion takes a shape of a spout.

### FIELD

Some implementations relate generally to apparatuses configured to retrieve, hold, and dispense material, and more particularly, to an apparatus for scooping solid and/or liquid material from one container and transferring the scooped material to another container.

### BACKGROUND

A variety of cooking ingredients may be sold in bulk quantities at wholesale markets. Examples include sugar, flour, and an assortment of agricultural products and cereal grains, including wheat, oats, and rice. Other dry products packaged in bulk include granola, cereal, beans, and lentils. These items can be sold, for example, in large volume containers, such as fifty-pound bags. The merchandising of bulk items is advantageous from a variety of perspectives. Bulk goods can be more economical on a unit price basis than goods sold in smaller quantities. Additionally, the container costs relative to the containers used for retail goods (e.g., glassware and plastic bottles) are significantly lower. For example, bulk food goods, especially those that are in granulated or powdered form, are typically packaged in inexpensive fabric or paper sacks, which also have the advantage of being more environment-friendly, for example, may be more amenable to recycling (paper versus glass versus plastic). However, storage of such large-sized bags in a residential environment may present a problem. For example, large-sized bags cannot usually be stored on shelves in kitchen cabinets, where cooking ingredients and the like are normally shelved, as large-sized bags are typically bulky and cumbersome to fit into such shelves. One solution is that the large-sized bags can be stored in a pantry area, if one is available. However, even the pantry solution is not feasible if multiple large-sized bags need to be stored. An additional concern is that not all homes may have pantry areas, and even those that do may not have sufficiently large pantry space to store large bags.

Another problem involves efficient and hygienic retrieval of ingredients from the large-sized bags. These bags are typically not resealable, making spillage and proper sealing of the bags (after opening them) a concern. Furthermore, it would likely be considered inefficient to make several back-and-forth trips to a pantry area to retrieve ingredients during the cooking process. In addition, a user needs to retrieve contents from the large-sized bags in a manner conducive to food preparation as cooking recipes typically require precise amounts of ingredients. In one approach, the user could use a small container to scoop material from the large-sized bags, and then pour the scooped material into a measuring cup to determine the required amount. However, in this example, the user would need to return the remaining material to the bag in the pantry. Moreover, the transfer process from one container to another may be time consuming, especially if ingredients from multiple bags need to be collected and measured. This multi-step process could be simplified or consolidated if the user uses a measuring cup to collect contents from the large-sized bags and scoops out the required amount from the bags. Even though this approach avoids the transfer of ingredients, the use of a measuring cup to retrieve contents from a bulk deposit may require several trail-and-error attempts to scoop and read the markings on the measuring cup when it is filled with material from the large-sized bags.

A more feasible solution is to transfer a manageable volume of ingredients from the large-sized bag to a smaller container—the latter can be stored in kitchen cabinets or in other suitable areas, such as a countertop. A subsequent material transfer can then be made from this smaller container into a measuring cup. Accordingly, in order for material from large-sized bags to be used in a kitchen environment, an apparatus or other means is required to transfer contents from the large-sized bags into a smaller, kitchen-compatible container. A cup, for example, can be used to retrieve the material from a large-sized bag, whereas a smaller-sized container, such as a bottle, can serve as the target receptacle to receive the contents of the cup. One drawback to such an approach, however, is that smaller-sized containers suitable for storing granulated goods typically have a small mouth, opening, or orifice. This constraint can make it difficult to transfer ingredients from a wide or large-mouthed cup into the small-mouthed container without spillage.

Accordingly, there is a need for a solution to the aforementioned problems. For instance, there is a need for a device, tool, or apparatus that is designed to transfer solid and/or liquid materials/substances from one container to another container by collecting the solids and/or liquids from one container and dispensing the collected solids and/or liquids into another container. There is also a need for such a device, tool, or apparatus that is easy to manipulate.

It may therefore be desirable to provide a new and improved apparatus that allows users to scoop material from a container using one end of the apparatus and release the scooped material into another container from another end of the apparatus. Such an apparatus can ensure that a single apparatus is used to both collect material from the first container and dispense the collected material into another container seamlessly/conveniently. Some implementations were conceived in light of the above-mentioned limitations, needs, or problems, among other things.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Some implementations include a scooping apparatus. The scooping apparatus can include a scoop portion that defines a scoop interior space. The scooping apparatus can also include a hollow handle portion that extends from the scoop portion and defines a handle interior space disposed in communication with the scoop interior space of the scoop portion.

In some implementations of the scooping apparatus, the hollow handle portion can be shaped as a spout. In some implementations of the scooping apparatus, the hollow handle portion can include a proximal end and a distal end. In some implementations of the scooping apparatus, the handle interior space tapers from the proximal end to the distal end. In some implementations of the scooping apparatus, the handle interior space of the hollow handle portion can include an ingress opening at the proximal end and an egress opening at the distal end. In some implementations of the scooping apparatus, the handle interior space can be shaped as a funnel.

In some implementations of the scooping apparatus, the scoop portion includes a sidewall body. In some implementations, the scoop portion includes an upper terminal peripheral edge.

In some implementations, the scooping apparatus can include a scoop portion that defines a scoop interior space and a hollow handle portion that extends from the scoop portion and defines a handle interior space, which is disposed in communication with the scoop interior space of the scoop portion. In some implementations of the scooping apparatus, the scoop portion can include a horizontally-extending lip that projects from an upper terminal peripheral edge of the scoop portion, the peripheral edge that is proximal to the hollow handle portion.

In some implementations of the scooping apparatus, the hollow handle portion can be shaped as a spout. In some implementations of the scooping apparatus, the hollow handle portion can include a proximal end and a distal end. In some implementations of the scooping apparatus, the handle interior space tapers from the proximal end to the distal end. In some implementations of the scooping apparatus, the handle interior space of the hollow handle portion can include an ingress opening at the proximal end and an egress opening at the distal end. In some implementations of the scooping apparatus, the handle interior space can be shaped as a funnel.

In some implementations of the scooping apparatus, the scoop portion includes a sidewall body. In some implementations of the scooping apparatus, the horizontally-extending lip can be shaped as a circular segment. In some implementations, the sidewall body of the scoop portion includes a planar side that is disposed in a direction that is opposite to the hollow handle portion.

In some implementations, the scooping apparatus includes a scoop portion that defines a scoop interior space and a hollow handle portion that extends from the scoop portion and defines a handle interior space, which is disposed in communication with the scoop interior space of the scoop portion. In some implementations of the scooping apparatus, the hollow handle portion of the scooping apparatus described can extend in an upwardly direction from the scoop portion.

In some implementations of the scooping apparatus, the scoop portion and/or the hollow handle portion can include (for example, be marked with) a scale with one or more units of measurement. In some implementations of the scooping apparatus, the scoop portion and/or the hollow handle portion can be made of one or more of a transparent or a translucent material.

### BRIEF DESCRIPTION OF THE DRAWINGS

FIG. 1 is a diagram showing a front perspective view of an example scooping apparatus in accordance with some implementations.

FIG. 2 is a diagram showing a rear perspective view of an example scooping apparatus in accordance with some implementations.

FIG. 3 is a diagram showing a top plan view of an example scooping apparatus in accordance with some implementations.

FIG. 4 is a diagram showing a side elevation view of an example scooping apparatus in accordance with some implementations.

FIG. 5 is a diagram showing a side elevation view of an example scooping apparatus deployed in an application environment in accordance with some implementations.

FIG. 6 is a diagram showing a side elevation view of an example scooping apparatus deployed in an application environment in accordance with some implementations.

FIG. 7 is a diagram showing a rear perspective view of an example scooping apparatus in accordance with some implementations.

FIG. 8 is a diagram showing a perspective view of an example scooping apparatus deployed in an application environment in accordance with some implementations.

FIG. 9 is a diagram showing a side-elevation cross-sectional view of an example scooping apparatus in accordance with some implementations.

FIG. 10 is a diagram showing a front perspective view of an example scooping apparatus in accordance with some implementations.

### DETAILED DESCRIPTION

The present disclosure is directed to an apparatus that is configured to facilitate the transfer of food and/or non-food material from a large-mouthed container to a small-mouthed container. In some implementations, the apparatus includes a scoop portion and a hollow handle portion that extends from the scoop portion. In some implementations, the hollow handle portion can define a spout structure that includes an ingress-forming proximal end and an egress-forming distal end. The hollow interior space of the hollow handle portion is disposed in fluid communication with an interior cavity or a receptacle space or an interior space of the scoop portion, thereby allowing contents of the scoop portion to pass through the hollow interior space of the hollow handle portion during a dispensing operation. In some implementations, the hollow interior space of the hollow handle portion can define a funnel-like configuration, with the funnel form or structure tapering from the proximal end to the distal end of the hollow handle portion.

The hollow handle portion has a generally octagonally-shaped transverse cross-section in some implementations. In some implementations, in an upright orientation of the apparatus, a lower-most surface edge of the hollow handle portion extends in a generally horizontal direction. The handle portion extends generally upwardly from the scoop portion in some implementations. The scoop portion includes a base as well as a sidewall body that extends from the base in some implementations. In some implementations, the sidewall body of the scoop portion includes a generally circular section and a generally flat planar side disposed opposite the hollow handle portion. The flat planar side enables the apparatus to engage the bottom surface of a container in flush contact to promote the collection of material from the container by sliding the apparatus to collect the material while maintaining flush contact on the planar side. In this position of the apparatus, the hollow handle portion extends in a direction that is generally vertically upwards.

In some implementations, the apparatus can be graduated with a set of measurement markings on the scoop portion to indicate a volumetric quantity of contents in one or more of the scoop portion and/or the hollow handle portion. In some implementations, the apparatus has a unibody construction. In some implementations, the apparatus is made of a transparent material.

In some implementations, the apparatus includes a scoop portion and a funnel-forming spout portion that extends from the scoop portion. The scoop portion includes an interior space or cavity to collect and hold the scooped material. The spout portion can include a conveyance space disposed in communication with the cavity of the scoop portion. The spout portion can be configured as a handle, obviating the need for a dedicated handle structure. The scoop portion can include a flat side that is opposite to the side from which the spout portion extends. In some implementations, the apparatus can rest on a flat surface on the flat side of the scoop portion.

In some implementations, the material collected by the scoop portion is dispensed via the spout portion. The tapered shape of the spout portion can allow the apparatus to transfer material from a large-mouthed container to a small-mouthed container by inserting the outlet-forming distal end of the spout portion into a small-sized opening. In some implementations, the apparatus can be provided with measurement markings on the scoop portion to indicate the volume of material disposed in the interior space of the scoop portion and/or the spout portion.

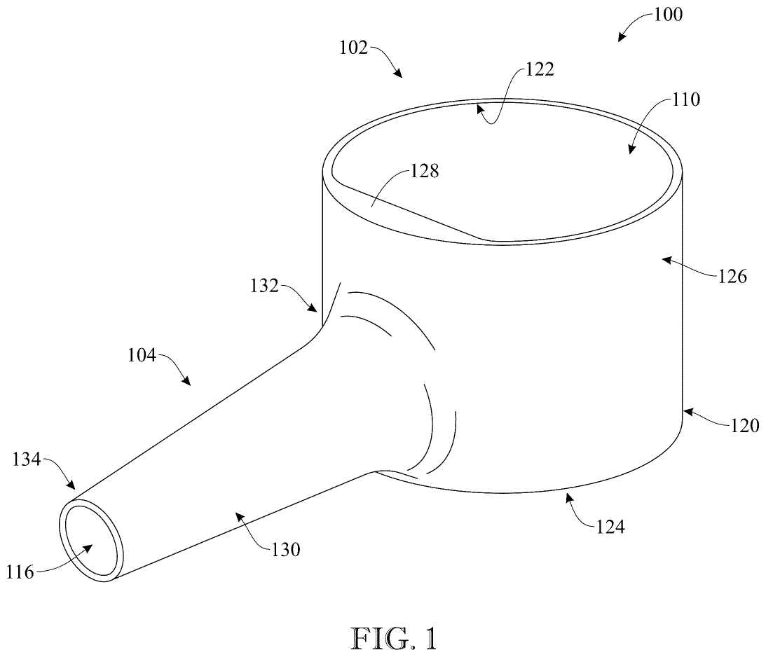

FIGS. 1-10 show diagrams of an example scooping apparatus (e.g., 100) and/or components thereof. Such example scooping apparatuses can, for example, be used to transfer material, e.g., solids or liquids, from one container to another container seamlessly/conveniently.

FIG. 1 is a diagram showing a front perspective view of an example scooping apparatus in accordance with some implementations. FIG. 1 shows a scooping apparatus 100. The scooping apparatus 100 shows a scoop portion 102 and a handle-capable spout portion 104. In some implementations, the spout portion 104 can be configured in a handle-forming, handle-defining, and/or funnel-defining construction. The scooping apparatus 100 can be used to collect and hold a suitable material or substance using the scoop portion 102 and to dispense the scooped contents via the spout portion 104. In some implementations, the spout portion can function as a handle to facilitate the maneuvering and/or the manipulation of the scooping apparatus in its operations, including, during the scooping process and the dispensing process. In some implementations, the scooping apparatus can be handle-free or handle-less. In some implementations, the scooping apparatus includes a scoop portion, a spout-defining portion or a spout-forming handle portion, and a hollow handle portion of the spout-forming handle that extends from the scoop portion.

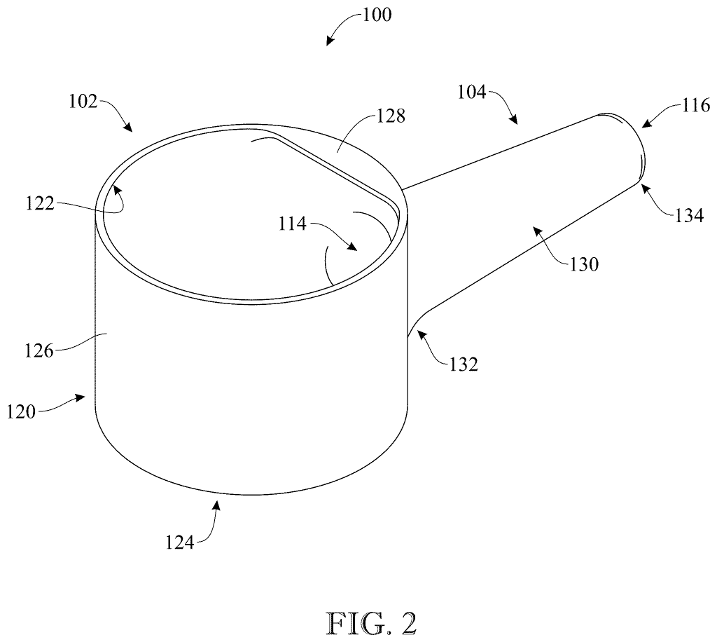

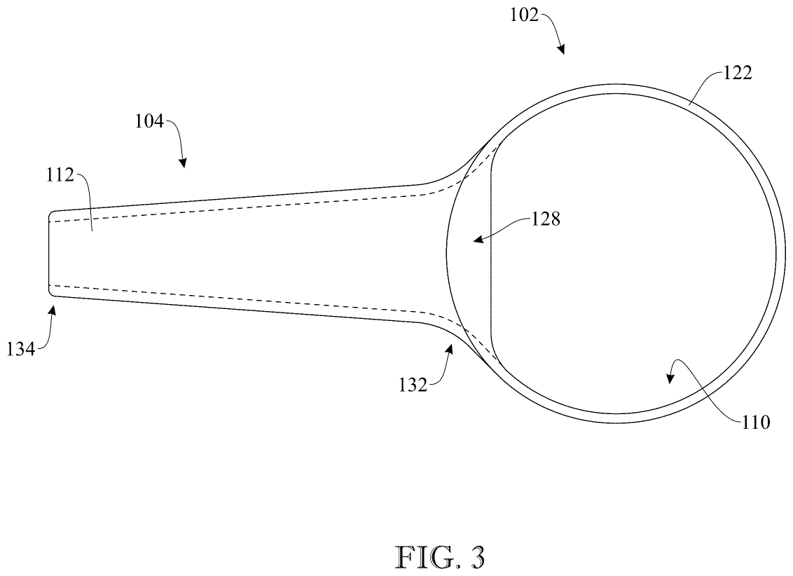

As shown in FIG. 1, the scoop portion 102 defines an interior collection space or cavity 110 that is configured to collect and hold solid and/or liquid materials and/or substances through, for example, a scooping action and/or using a scooping operation. The hollow spout-forming handle portion 104 shown in FIG. 1 defines an interior conveyance or passage space 112 (shown in FIG. 3) that extends between an inlet opening or ingress 114 (shown in FIG. 2) and an outlet opening or egress 116 (shown in FIG. 1). In FIG. 1, the interior space 110 of the scoop portion 102 is disposed in communication with the interior space 112 (shown in FIG. 3) of the handle portion 104. The handle portion 104 can be configured to transfer and/or communicate contents of the scoop portion 102 from the inlet 114 (shown in FIG. 2) to the outlet 116 through, for example, a funnel-type dispensing action or operation. In some implementations of the scooping apparatus 100 shown in FIG. 1, the hollow handle portion 104 can be configured in a funnel-type configuration to facilitate the conveyance, transfer, pouring, and/or dispensing of scooped contents from the scoop portion 102 in a controlled, guided, metered, and/or regulated manner.

As shown in FIG. 1, the scoop portion 102 includes a generally cylindrical open-top body 120 having a generally flat or planar base 124. The body 120 of the scoop portion 102 shown in FIG. 1 includes a generally curved sidewall portion 126. In some implementations of the scooping apparatus 100, the scoop portion 102 has a cup-shaped configuration. As shown in FIG. 1, the body 120 defines a receptacle and/or a container configured to receive and hold contents, e.g., solid/liquid substances/material. The body 120 of the scoop portion 102 shown in FIG. 1 includes an upper terminal edge 122. The body 120 of the scoop portion 102 shown in FIG. 1 also includes an upper projecting peripheral lip 128. As shown in FIG. 1, the projecting lip 128 extends generally horizontally inward from the upper terminal edge 122 (shown in FIG. 1) at a location disposed above the inlet 114 (shown in FIG. 2) of the interior passageway 112 (shown in FIG. 3) of the handle portion 104. In some implementations of the scooping apparatus 100, the projecting lip 128 can take the form of a circular segment. In some implementations, the horizontally-extending projecting lip 128 of the edge 122 can define a hood-like component.

As shown in FIG. 1, the hollow handle portion 104 of the scooping apparatus 100 includes a generally elongate tubular body 130 that extends between a proximal end 132 and a distal end 134 of the hollow handle portion 104. Other exemplary features or aspects of the hollow handle portion 104 shown in FIG. 2 and FIG. 3 are discussed in further detail the following paragraphs.

FIG. 2 is a diagram showing a rear perspective view of an example scooping apparatus in accordance with some implementations. In addition to the features and aspects shown in FIG. 1, FIG. 2 shows an inlet 114. The inlet 114 corresponds to an interior passageway 112 (shown in FIG. 3) of the hollow handle portion 104 and is disposed at the proximal end 132 of the body 130, whereas the outlet 116 of the passageway 112 (shown in FIG. 3) is disposed at the distal end 134 of the hollow handle portion 104 of the scooping apparatus shown in FIG. 1, FIG. 2, and FIG. 3.

FIG. 3 is a diagram showing a top plan view of an example scooping apparatus in accordance with some implementations. The interior passageway 112 referred to above in reference to FIG. 2 is shown in FIG. 3 using dashes. In some implementations of the scooping apparatus 100, the interior passageway 112 of the hollow handle portion 104 tapers (e.g., narrows gradually/progressively) from the proximal end 132 of the body 130 to the distal end 134 of the body 130 so as to define a configuration that is generally shaped like a funnel. The interior cavity space 110 of the scoop portion 102 is disposed in communication with the interior passageway 112 of the hollow handle portion 104 via the inlet 114 (shown in FIG. 2). In some implementations, the hollow handle portion 104 extends generally horizontally from the scoop portion 102 to facilitate the use of the hollow handle portion 104 as both a spout and a handle.

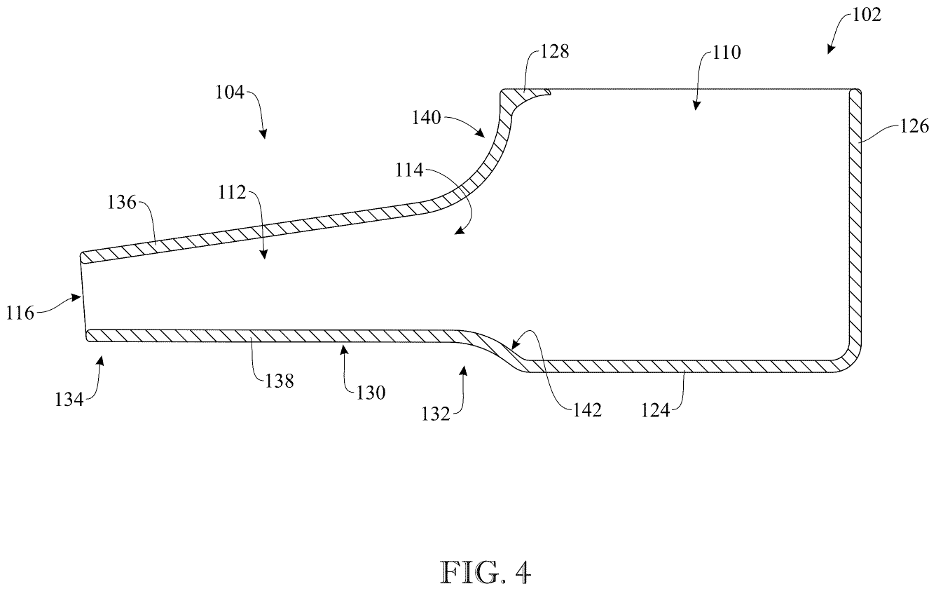

FIG. 4 is a diagram showing a side elevation view of an example scooping apparatus in accordance with some implementations. The body 130 of the hollow handle portion 104 shown in FIG. 4 includes an uppermost edge 136 and a lowermost edge 138. As shown in FIG. 4, the uppermost edge 136 of the body 130 of the hollow handle portion 104 joins and connects via a curved upper transition surface 140 to the upper terminal peripheral edge 122 (shown in FIG. 1) of the body 120 (shown in FIG. 1) of the scoop portion 102. As shown in FIG. 4, the lowermost edge 138 of the body 130 of the hollow handle portion 104 joins and connects via a curved lower transition surface 142 to the base 124 of the body 120 (shown in FIG. 1) of the scoop portion 102.

In some implementations of the scooping apparatus 100, the uppermost edge 136 of the body 130 of the hollow handle portion 104 extends generally downwards from the proximal end 132 to the distal end 134 of the body 130 of the hollow handle portion 104. The lowermost edge 138 of the body 130 of the hollow handle portion 104 extends in a generally horizontal direction (parallel to the base 124 (shown in FIG. 1)) from the proximal end 132 to the distal end 134 of the body 130 of the hollow handle portion 104. The curvature of the upper transition surface 140 and the curvature of the lower transition surface 142 can be adjusted and/or selected to locate the hollow handle portion 104 at different positions of extension from the body 120 (shown in FIG. 1) of the scoop portion 102, depending on, for example, one or more of the sizes of the scoop portion 102 and/or the hollow handle portion 104 as well as the materials that are being scooped.

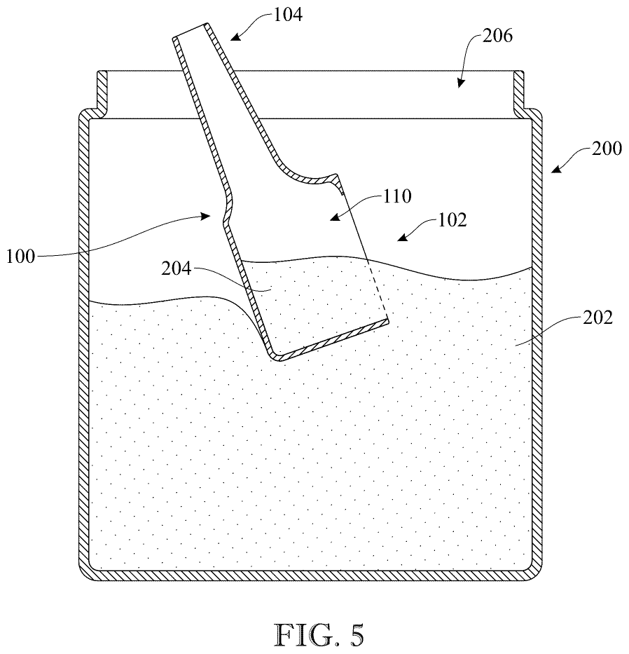

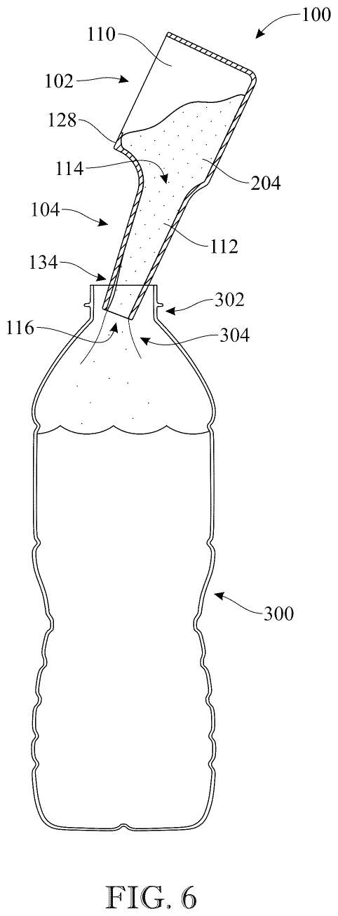

FIG. 5 is a diagram showing a side elevation view of an example scooping apparatus deployed in an application environment in accordance with some implementations. FIG. 6 is a diagram showing a side elevation view of an example scooping apparatus deployed in an application environment in accordance with some implementations. As shown in FIGS. 5 and 6, the scooping apparatus 100 can be used to transfer contents of a wide-mouthed source container 200 (shown in FIG. 5) to a narrow-mouthed target container, e.g., a bottle, 300 (shown in FIG. 6).

The container 200 shown in FIG. 5 is filled or loaded with material 202, e.g., a granular material. In an example scooping operation, a user (not shown in FIGS. 1 to 10) can hold and manipulate the scooping apparatus 100 using the hollow handle portion 104. The user can hold the scooping apparatus 100 at the hollow handle portion 104 and maneuver the scooping apparatus 100 through an open top 206 of the container 200. Employing an example scooping motion, the user can collect and scoop a portion 204 of the material 202 into the interior collection space or cavity or receptacle space 110 of the scoop portion 102. The user can remove the scooping apparatus 100 from the container 200 by holding the scooping apparatus 100 upright so that the scooped content or portion 204 does not spill out of the scoop portion 102.

As shown in FIG. 6, the scooped content or portion 204 of the material 202 can be transferred from the scooping apparatus 100 to the bottle 300. The bottle 300 shown in FIG. 6 includes a narrow neck or mouth opening 302. To facilitate the transfer, a user (not shown in FIG. 6) can insert the distal end 134 of the hollow handle portion 104 of the scooping apparatus 100 into the mouth or neck 302 of the bottle 300. The user can then tilt or angle the scooping apparatus 100 so that the scooped content or portion 204 in the scoop portion 102 can flow into the passageway 112 of the hollow handle portion 104 through the inlet 114. The scooped content 204 then flows through the passageway 112 of the hollow handle portion 104 from the proximal end 132 to the distal end 134 in a funneling action, under the influence of gravity. The scooped content or portion 204 then flows through the passageway 112 of the hollow handle portion 104, emerges from the outlet 116, and is transferred into the bottle 300 as transferred material 304.

During the dispensing operation described above, the hood or projecting lip 128 of the scoop portion 102 can help retain material in the scoop portion 102 as the scooped content or portion 204 in the scoop portion 102 is transferred into the conveyance passage 112 of the hollow handle portion 104, thereby preventing spillage of the scooped content 204 over the upper terminal edge 122 (shown in FIG. 3), which is in the proximity of the inlet 114 of the conveyance passage 112 of the hollow handle portion 104. As shown in FIG. 6, the tilting of the scooping apparatus 100 causes the scooped content 204 to move through the interior collection space or cavity or receptacle space 110 and migrate towards the inlet 114 to occupy space around the inlet 114 of the hollow handle portion 104. The projecting lip 128 can serve as a curb or as a stop to prevent spillage of the scooped content 204 during its accumulation around the upper terminal edge 122 of the body 120 (both shown in FIG. 1 and FIG. 2) of the scoop portion 102.

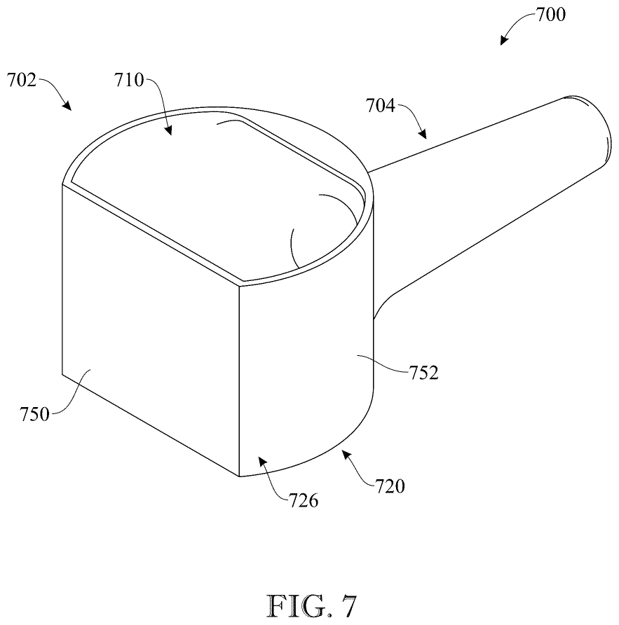

FIG. 7 is a diagram showing a rear perspective view of an example scooping apparatus in accordance with some implementations. As shown in FIG. 7, a sidewall 726 of a body 720 of a scoop portion 702 of a scooping apparatus 700 includes a generally planar flat side 750, which is joined to a curved section 752 of the body 720, so that the body 720 of the scoop portion 702 generally defines a truncated cylindrical shape. The flat side 750 is disposed generally opposite a handle portion 704 of the scooping apparatus 700. FIG. 7 also shows a scoop interior space 710.

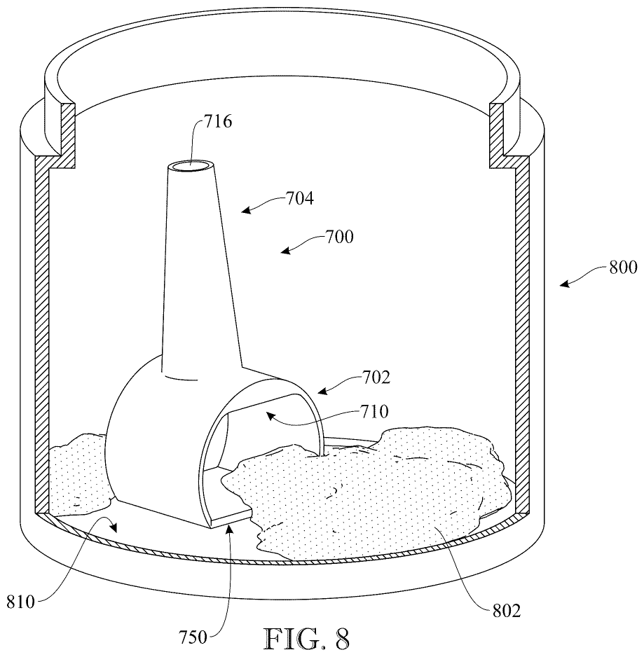

FIG. 8 is a diagram showing a perspective view of an example scooping apparatus deployed in an application environment in accordance with some implementations. As shown in FIG. 8, during a collection or a scooping operation, the scooping apparatus 700 can be used to transfer content from a container 800 with material 802 lying on a flat bottom side 810 of the container 800. The apparatus 700 can be placed in container 800 by seating the flat side 750 of the scoop portion 702 on the flat bottom side 810 of the container 800. In this position, the handle portion 704 is oriented vertically upwards. A user (not shown) can scoop material 802 from the container 800 by manipulating the handle portion 704. The scooping operation can be facilitated by appropriately positioning the flat side 750 of the scoop portion 702, for example, when the material 802 in the container 800 is less and the flat bottom side 810 is partly exposed.

In situations where the flat bottom side 810 is partly exposed, the scooping operation can collect material by maintaining the flat side 750 of the body 720 of the scoop portion 702 in a flush, abutting engagement with the flat bottom side 810 of the container 800 while the apparatus 100 is moved laterally, producing a surface-to-surface contact that can facilitate the recovery and the collection of material 802 into the interior collection space 710 of the scoop portion 702. The scooped content can thereafter be dispensed in a manner similar to that disclosed in FIG. 6 above.

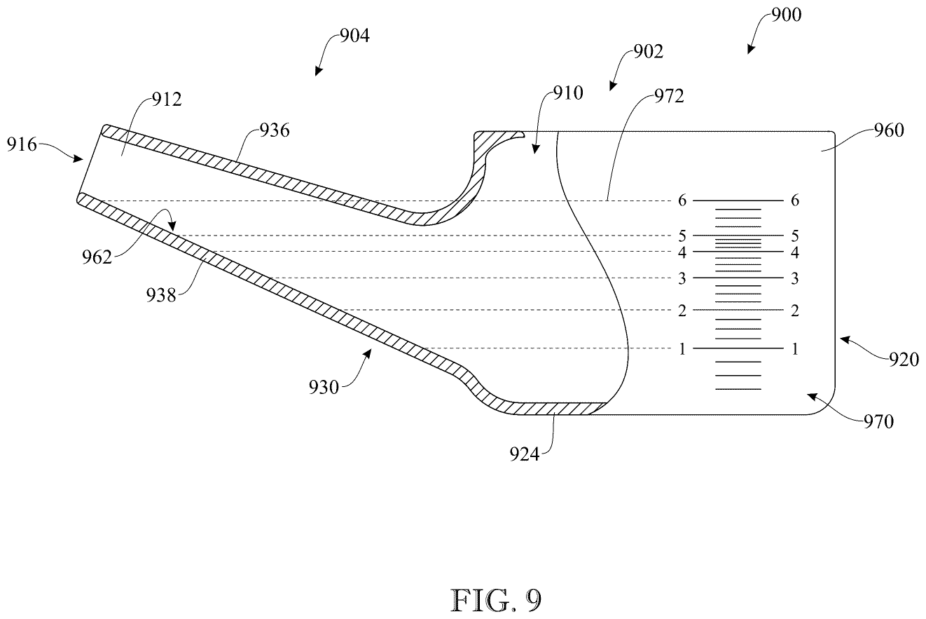

FIG. 9 is a diagram showing a side-elevation cross-sectional view of an example scooping apparatus in accordance with some implementations. As shown in FIG. 9, a handle portion 904 of a scooping apparatus 900 slopes, inclines, and/or extends generally upwards from a scoop portion 902. An outer surface 960 of a body 920 of the scoop portion 902 is marked with a visible measurement scale 970, including a set of markings or volumetric fill lines 972, each indicating an amount or a volume of content in an interior collection space or cavity 910 of the scoop portion 902 at a corresponding one of the fill lines 972. In some implementations, the graduated measurement scale 970 can include an irregular interval of fill lines marking off units of measurement to accommodate an angled orientation of the spout-forming handle portion 904.

As shown in FIG. 9, each fill line 972 can extend horizontally to a location on an inner surface 962 of an interior passageway 912 of a body 930 of the handle portion 904. Each fill line 972 represents or signifies a volume of content that additively includes the material in the scoop portion 902 and the material in the handle portion 904. In some implementations, the body 920 of the scoop portion 920 can be transparent to enable a user (not shown) to see the contents of the scoop portion 902 in relation to the fill lines or markings 972 of the measurement scale 970.

In some implementations of the scooping apparatus 900, the handle portion 904 can be used as a storage component (in addition to the scoop portion 902) as the upward extension or orientation of the handle portion 904 allows material to accumulate in the hollow passageway 912 of the handle portion 904 without any possibility of spillage, i.e., the contents of passageway 912 of the handle portion 904 accumulate below an outlet 916. In some implementations, the apparatus 900 (a combination of scoop portion 902 and handle portion 904) can be transparent.

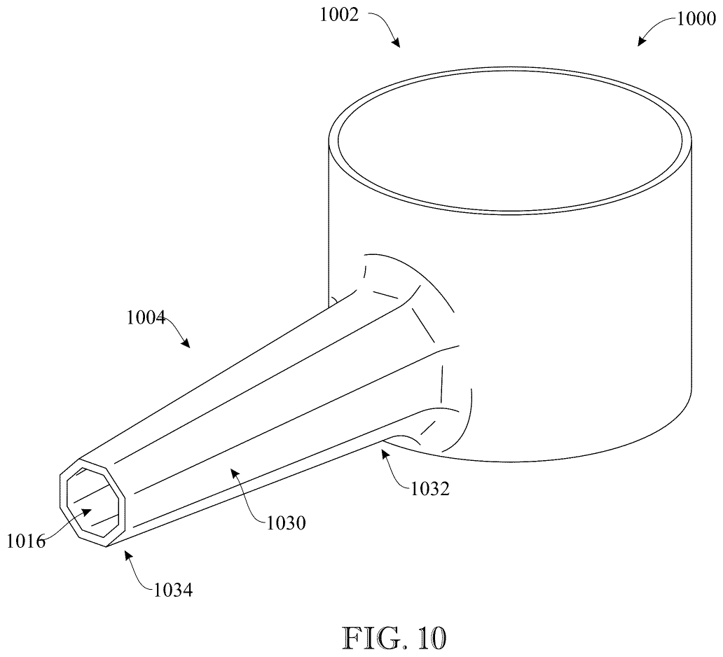

FIG. 10 is a diagram showing a front perspective view of an example scooping apparatus in accordance with some implementations. As shown in FIG. 10, a handle portion 1004 of a scooping apparatus 1000 has a generally octagonally-shaped transverse cross-section. An interior conveyance passageway 1012 of the handle portion 1004 shown in FIG. 10 can be sized, shaped, and dimensioned to accommodate any range and any type of pouring and/or dispensing actions.

The handle portion 1004 is designed in a funnel configuration in some implementations to facilitate an efficient and/or controllable pouring and/or dispensing operation/action. Also, the handle portion 1004 of the scooping apparatus 1000 shown in FIG. 10 can be configured in any suitable manner for facilitating a desired dispensing and/or pouring operation and/or action.

The features of the scooping apparatuses shown in FIGS. 1-10 can be integrated in any combination to produce a variety of configurations of the scooping apparatuses described above. The scooping apparatus can be used to transfer solid and/or liquid substances and/or material from one container/receptacle to another container/receptacle in some implementations of the apparatus. It will be appreciated that the scooping apparatus described herein is for illustration purposes only and is not intended to be limiting. Other apparatuses may be used depending on a contemplated implementation. In some implementations, the scooping apparatus is made of a single, integrated, unibody, or unitary construction, with the apparatus formed as a single unit.

An example process/method for transferring material from one container to another container using a scooping apparatus includes the following steps. In some implementations, one step can include manipulating the scooping apparatus described above to collect material from a source container via the scoop portion through a scooping action. Another step can include inserting the distal end of the handle portion into the mouth of the destination or target container, e.g., a small-mouthed bottle. In yet another step, the apparatus is suitably manipulated to initiate a pouring action, through which, the contents of the scoop portion pass through the hollow interior space of the handle portion and get dispensed into the target container. The handle portion can be suitably sized, shaped, and dimensioned so that its distal end is effective in facilitating the transfer of material from large mouthed containers to small-mouthed containers.

A benefit of the disclosed scooping apparatus is that it can be used to transfer solid and/or liquid substances and/or material from one container/receptacle to another container/receptacle. The scooping apparatus can process a variety of materials and substances in solid, semi-solid, and/or liquid form, including, but not limited to, powders, small particle and/or granular items, gels, liquids, and any other pourable and/or flowable material. The scooping apparatus can be equipped, for example, to manipulate, process, and handle granular foodstuffs such as sugar, powdered materials such as flour, fine-grained materials, and other grains, including, for example, rice) as well as non-food materials, including natural, synthetic, composite materials.

In some implementations, the dimensions of an example scooping apparatus can be . . . . It will be appreciated that any dimensions described herein are for illustration purposes only and are not intended to be limiting. Other dimensions could be used depending on a contemplated implementation.

It is therefore apparent that there are provided, in accordance with the various example implementations disclosed herein, a scooping apparatus.

While the disclosed subject matter has been described in conjunction with a number of implementations, it is evident that many alternatives, modifications, equivalents, substitutes, and variations would be or are apparent to those of ordinary skill in the applicable arts. Accordingly, Applicant intends to embrace all such alternatives, modifications, equivalents, substitutes, and variations that are within the spirit and scope of the disclosed subject matter.

What is claimed is:

1. A scooping apparatus comprising:
a scoop portion defining a scoop interior space; and
a hollow handle portion extending from the scoop portion and defining a handle interior space disposed in communication with the scoop interior space of the scoop portion.

2. The scooping apparatus of claim 1, wherein the hollow handle portion is shaped as a spout.

3. The scooping apparatus of claim 1, wherein the hollow handle portion includes a proximal end and a distal end.

4. The scooping apparatus of claim 3, wherein the handle interior space of the hollow handle portion includes an ingress opening at the proximal end and an egress opening at the distal end.

5. The scooping apparatus of claim 1, wherein the scoop portion includes a sidewall body.

6. The scooping apparatus of claim 1, wherein the handle interior space is shaped as a funnel.

7. The scooping apparatus of claim 3, wherein the handle interior space tapers from the proximal end to the distal end.

8. The scooping apparatus of claim 1, wherein the scoop portion includes an upper terminal peripheral edge.

9. A scooping apparatus comprising:
a scoop portion defining a scoop interior space; and
a hollow handle portion extending from the scoop portion and defining a handle interior space disposed in communication with the scoop interior space of the scoop portion,
wherein the scoop portion includes a horizontally-extending lip projecting from an upper terminal peripheral edge of the scoop portion that is proximal to the hollow handle portion.

10. The scooping apparatus of claim 9, wherein the hollow handle portion is shaped as a spout.

11. The scooping apparatus of claim 9, wherein the hollow handle portion includes a proximal end and a distal end.

12. The scooping apparatus of claim 11, wherein the handle interior space of the hollow handle portion includes an ingress opening at the proximal end and an egress opening at the distal end.

13. The scooping apparatus of claim 9, wherein the scoop portion includes a sidewall body.

14. The scooping apparatus of claim 9, wherein the handle interior space is shaped as a funnel.

15. The scooping apparatus of claim 11, wherein the handle interior space tapers from the proximal end to the distal end.

16. The scooping apparatus of claim 9, wherein the horizontally-extending lip is shaped as a circular segment.

17. The scooping apparatus of claim 13, the sidewall body of the scoop portion includes a planar side that is disposed opposite to the hollow handle portion.

18. A scooping apparatus comprising:
a scoop portion defining a scoop interior space; and
a hollow handle portion extending from the scoop portion and defining a handle interior space disposed in communication with the scoop interior space of the scoop portion,
wherein the hollow handle portion extends in an upwardly direction from the scoop portion.

19. The scooping apparatus of claim 18, wherein one or more of the scoop portion or the hollow handle portion includes a scale with one or more units of measurement.

20. The scooping apparatus of claim 18, wherein one or more of the scoop portion or the hollow handle portion is made of one or more of a transparent or translucent material.
